(19) United States
(12) Patent Application Publication
(10) Pub. No.: US 2020/0395593 A1
(43) Pub. Date: Dec. 17, 2020

(54) ANODE PRE-LITHIATION FOR HIGH ENERGY LI-ION BATTERY

(71) Applicant: A123 Systems LLC, Waltham, MA (US)

(72) Inventors: Xiangyang Zhu, Waltham, MA (US); Weidong Zhou, Winchester, MA (US); Jun Wang, Shrewsbury, MA (US); Hong Yan, Hangzhou (CN); Derek C. Johnson, Fort Collins, CO (US)

(21) Appl. No.: 16/900,352

(22) Filed: Jun. 12, 2020

Related U.S. Application Data
(60) Provisional application No. 62/860,686, filed on Jun. 12, 2019.

(51) Int. Cl. H01M 4/04; H01M 10/0525; H01M 4/587; H01M 4/36; H01M 4/48; H01M 10/058

(52) U.S. Cl. CPC H01M 4/0459; H01M 10/0525; H01M 4/587; H01M 2004/027; H01M 4/483; H01M 10/058; H01M 4/364

(57) ABSTRACT

Methods and systems are provided for fabricating a large format lithium ion electrochemical cell that includes an anode and a cathode. In one example, the anode is prepared via loading the anode to a predetermined anode loading amount, followed by electrochemical pre-lithiation of the anode via electrically coupling an auxiliary electrode to the anode where lithium is transferred to the anode through an electrolyte solution from the auxiliary electrode. In this way, pre-lithiation of the anode may be improved, which may in turn increase a capacity of the large format lithium ion electrochemical cell.

### CROSS REFERENCE TO RELATED APPLICATIONS

The present application claims priority to U.S. Provisional Application No. 62/860,686, entitled “ANODE PRE-LITHIATION FOR HIGH ENERGY LI-ION BATTERY,” and filed on Jun. 12, 2019. The entire contents of the above-identified application are hereby incorporated by reference for all purposes.

### FIELD

The present description relates generally to strategies for anode pre-lithiation for use in lithium ion batteries.

### BACKGROUND AND SUMMARY

Lithium (Li) ion batteries are and have been widely used in a number of different applications, including, but not limited to, consumer electronics, uninterruptible power supplies, transportation, and stationary applications. Li ion batteries function by passing Li ions from a positive electrode, or cathode, including positive electrode active materials, to a Li-based negative electrode, or anode, during charging and then passing Li ions back to the cathode from the anode during discharge. A necessary consequence of the charge/discharge process is the formation of a solid-electrolyte interphase (SEI) layer on the anode during the first charge cycle. Specifically, some of the Li from the cathode during the first charge cycle is consumed to form the SEI on the anode surface, leading to high irreversible capacity and low initial columbic efficiency during the first charge cycle.

To counter low efficiency due to anodic SEI formation, a pre-lithiation approach may be employed to offset the lithium loss on the anode surface. Such a pre-lithiation approach may be accomplished in a number of ways, such as use of stabilized lithium metal powder (SLMP), thin Li foil, and electrochemical approaches to pre-lithiate the anode. However, there are potential issues with such approaches. For example, it may be challenging to control a rate to which the anode is pre-lithiated for at least the pre-lithiation strategies that employ the use of SLMP and thin Li foil. Inability to control the rate may lead to inefficient and/or non-uniform anode pre-lithiation, which may thus in turn affect battery parameters including but not limited to first charge capacity, first discharge capacity, initial coulombic efficiency, and capacity retention. Electrochemical pre-lithiation methodology is an approach which could control the rate but its efficiency of pre-lithiation fluctuates with different cell design chemistry. The efficiency of pre-lithiation with electrochemical method could be low even though the voltage of pre-lithiation step may be well controlled. Similar to that discussed above, non-optimal anode pre-lithiation may lead to degraded battery parameters related to charge/discharge capacity, coulombic efficiency, and capacity retention.

The inventors have identified the above-mentioned issues and have herein developed solutions to at least partially address these issues. In one example, a method for improving a capacity of a lithium ion battery may include providing a three-electrode system that includes a cathode, an anode, and an auxiliary electrode. As described, the method includes determining an anode loading amount and loading the anode to the determined anode loading amount, and pre-lithiating the anode with lithium from the auxiliary electrode, where a pre-lithiation efficiency is based on the anode loading amount. For example, the method may include controlling the anode loading amount in order to increase pre-lithiation of the anode.

As examples, the auxiliary electrode may be a lithium metal electrode, a lithium iron phosphate electrode, a NiCoMn electrode or a NiCoAl electrode. The anode may include graphite, silicon/graphite, silicon oxide/graphite, silicon or silicon oxide (SiOx), etc.

In one example, a rate and or a degree to which the anode is pre-lithiated may be controlled. Controlling the rate may include adjusting a current density that is used for pre-lithiating the anode. Controlling the degree to which the anode is pre-lithiated may include controlling a duration whereby the anode is pre-lithiated.

Such a method may in some examples improve the capacity of the lithium battery such that an initial coulombic efficiency is approximately 90%. Additionally or alternatively, such a method may in some examples improve the capacity of the lithium ion battery such that a first discharge capacity under 0.1C is greater than 83 ampere hours. Additionally or alternatively, such a method may in some examples improve the capacity of the lithium ion battery such that a second discharge capacity under 0.3C is greater than 83 ampere hours.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1A depicts an example three-electrode strategy for anode pre-lithiation using Li metal as an auxiliary electrode.

FIG. 1B depicts an example three-electrode strategy for anode pre-lithiation using LiFePO₄ as an auxiliary electrode.

FIG. 2 depicts an example graph comparing cycling performance between cells pre-lithiated with the strategy of FIG. 1A, as compared to non-pre-lithiated control cells, for double-layered small pouch cells.

FIG. 3 depicts an example graph comparing cycling performance between cells pre-lithiated with the strategy of FIG. 1A, as compared to non-pre-lithiated control cells, for multi-layered small pouch cells.

FIG. 4 depicts an example graph comparing cycling performance between cells pre-lithiated with the strategy of FIG. 1B, as compared to non-pre-lithiated control cells, for double-layered small pouch cells.

FIG. 5 depicts an example graph comparing cycling performance between cells pre-lithiated with the strategy of FIG. 1B, as compared to non-pre-lithiated control cells, for multi-layered small pouch cells.

FIG. 6A depicts an example method for controlling anode pre-lithiation based on anode loading amount for improving a capacity of a lithium ion battery.

FIG. 6B depicts an example method using the strategy of FIG. 6A for generating a large format electrochemical cell.

FIG. 7 depicts an example illustration of a large-format pouch cell before and after an electrochemical pre-lithiation step.

FIG. 8 shows example voltage profiles for the pre-lithiation step on large-format pouch cells.

FIG. 9 depicts an example graph comparing the cycling performance for double-layered small pouch cells generated by the strategy of FIG. 1A, as compared to an SLMP method.

FIG. 10 depicts an example graph comparing the cycling performance for double-layered small pouch cells generated by the strategy of FIG. 1A, as compared to an ultra-thin Li foil method.

FIG. 11 depicts an example graph comparing the cycling performance for double-layered small pouch cells generated by the strategy of FIG. 1A, as compared to an alternative electrochemical approach.

FIG. 12 depicts an example graph comparing the cycling performance for double-layered small pouch cells generated by the strategy of FIG. 1B, as compared to the SLMP approach.

FIG. 13 depicts an example graph comparing the cycling performance for double-layered small pouch cells generated by the strategy of FIG. 1B, as compared to the ultra-thin Li foil method.

FIG. 14 depicts an example graph comparing the cycling performance for double-layered small pouch cells generated by the strategy of FIG. 1B, as compared to the alternative electrochemical approach.

### DETAILED DESCRIPTION

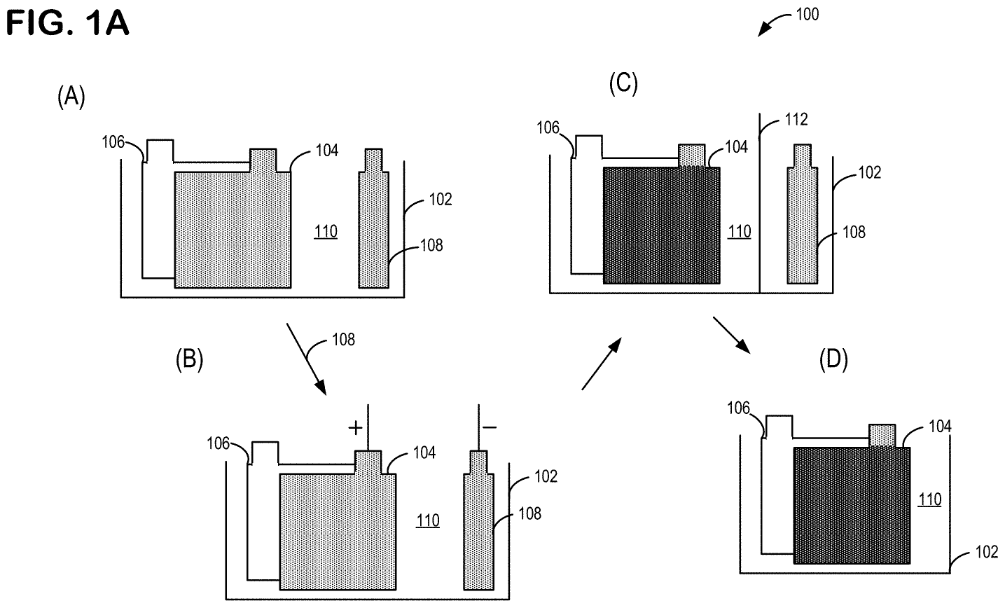

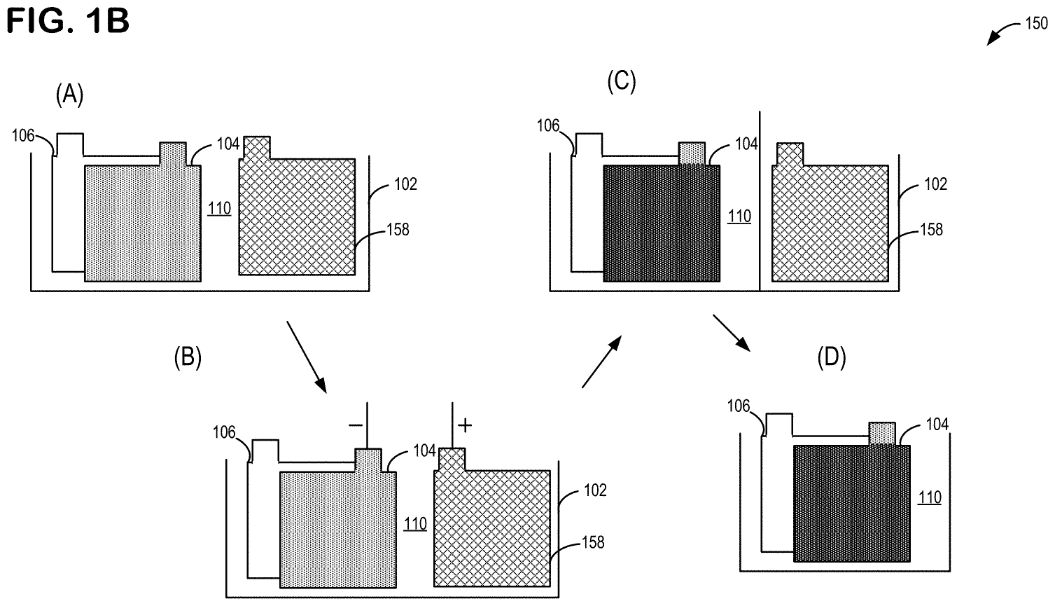

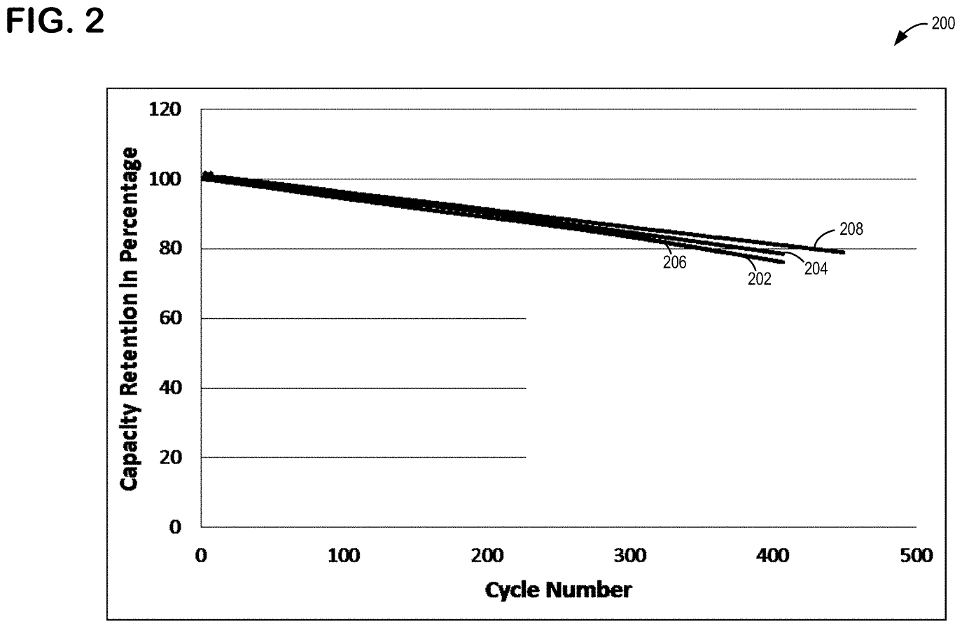

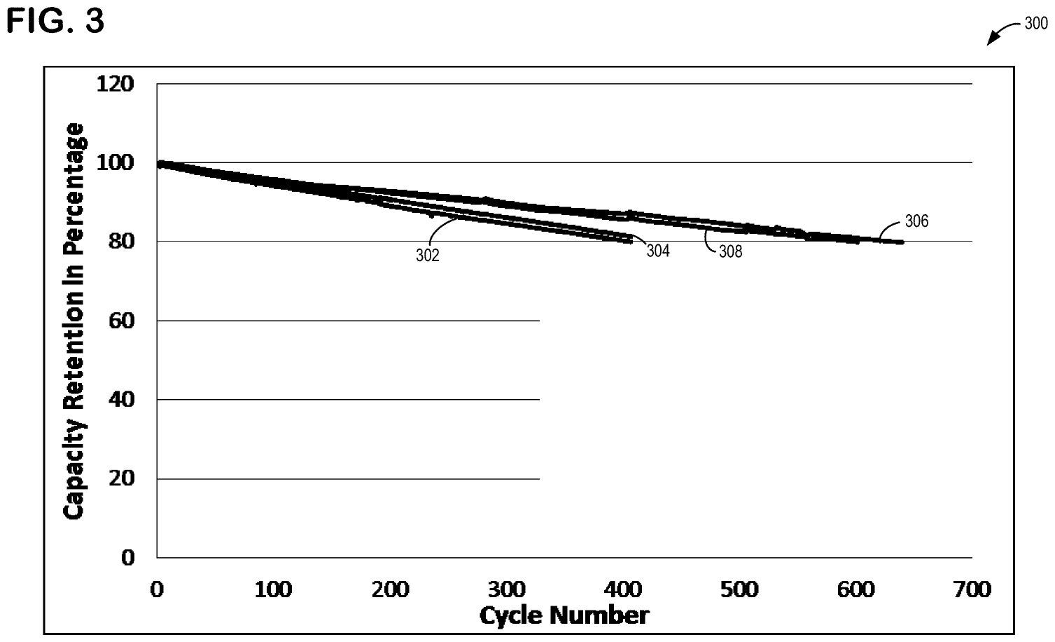

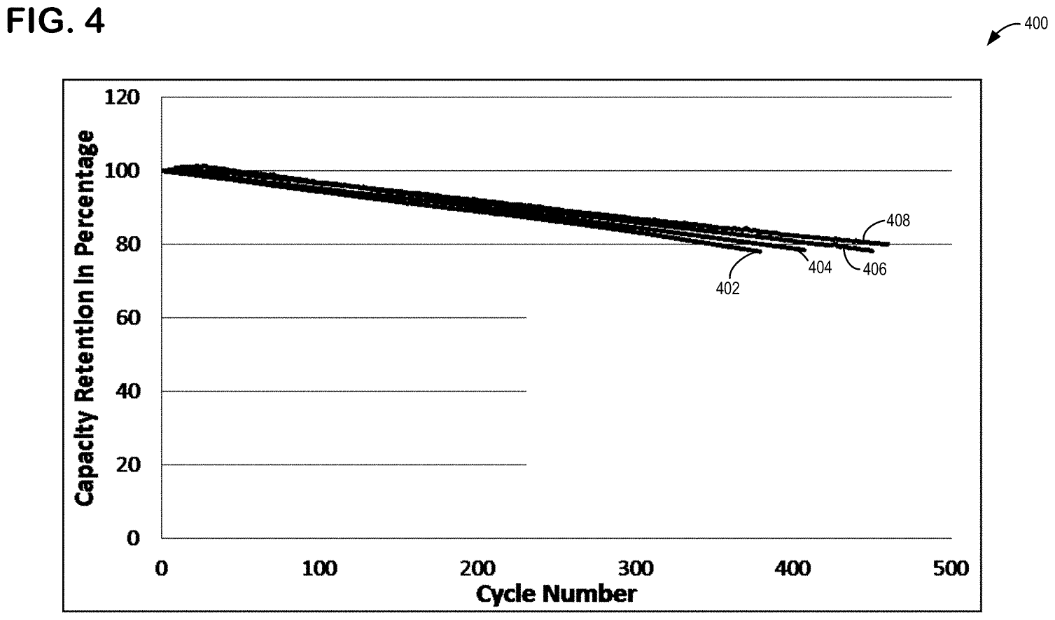

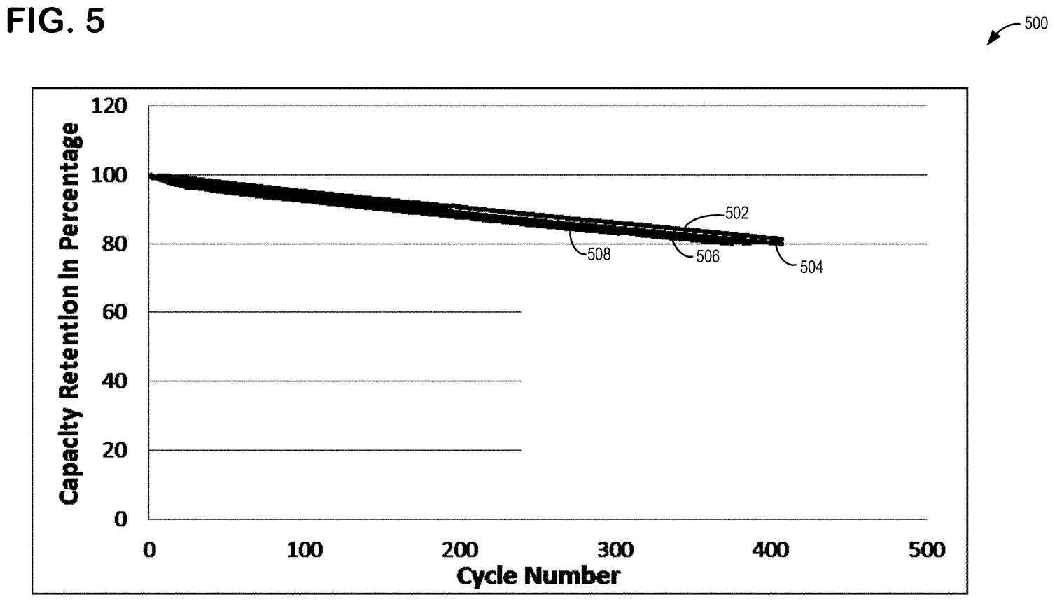

The following description relates to systems and methods for anode pre-lithiation strategies. Examples of pre-lithiation strategies are discussed in terms of both small pouch cells and large format pouch cells using a three-electrode electrochemical approach for anode pre-lithiation. FIG. 1A depicts an example anode pre-lithiation strategy using the three-electrode system where an auxiliary electrode used for anode pre-lithiation is Li metal, and FIG. 1B depicts an example anode pre-lithiation strategy using the three-electrode system where the auxiliary electrode is LiFePO₄. An example comparison of cycling performance for double-layered small pouch cells pre-lithiated with the strategy of FIG. 1A versus non-pre-lithiated double-layered small pouch cells, is depicted at FIG. 2. FIG. 3 depicts an example comparison of cycling performance for multi-layered small pouch cells pre-lithiated with the strategy of FIG. 1A versus non-pre-lithiated multi-layered small pouch cells. An example comparison of cycling performance for double-layered small pouch cells pre-lithiated with the strategy of FIG. 1B versus non-pre-lithiated double-layered small pouch cells is depicted at FIG. 4. FIG. 5 depicts an example comparison of cycling performance for multi-layered small pouch cells pre-lithiated with the strategy of FIG. 1B versus non-pre-lithiated multi-layered small pouch cells.

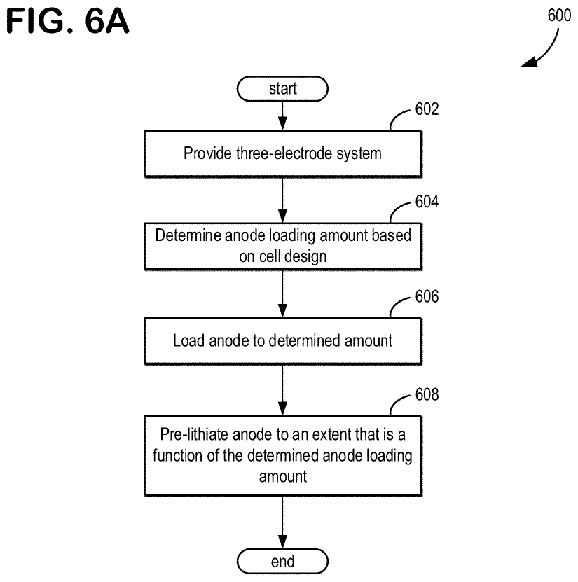

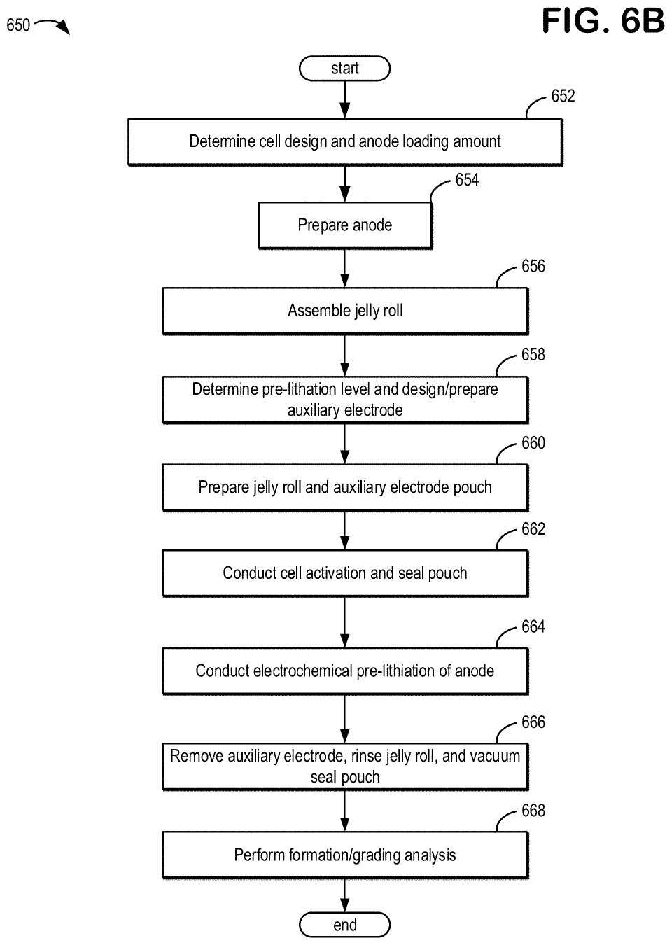

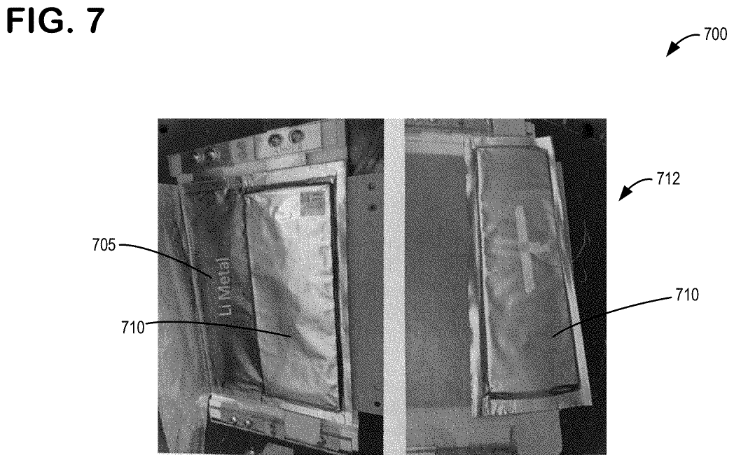

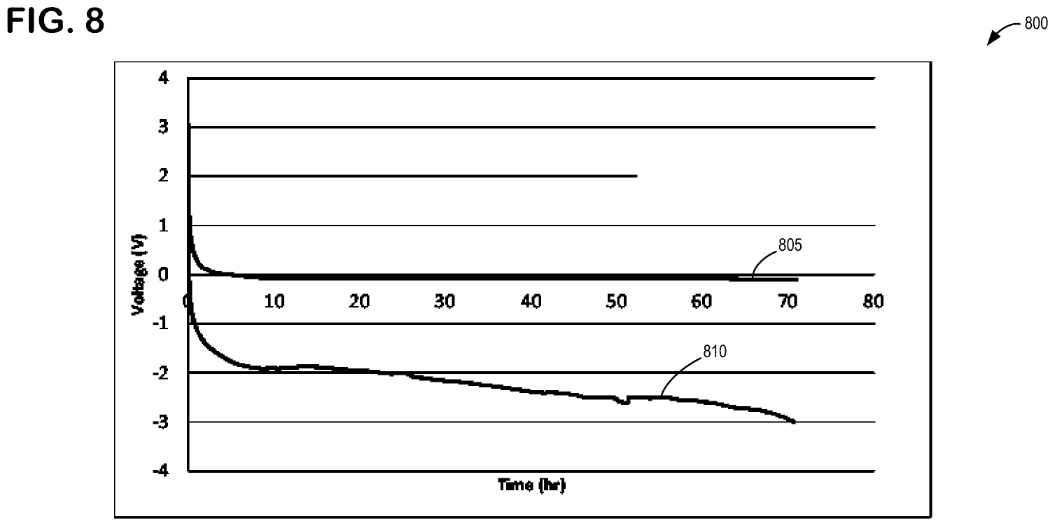

Disclosed herein, an unexpected process has been developed for use with the three-electrode system discussed above which improves anode pre-lithiation efficiency in large format cells. Accordingly, an example method for improving a capacity of a lithium ion battery by improving an efficiency of anode pre-lithiation in large format cells is depicted at FIG. 6A. An example method using the strategy of FIG. 6A for fabricating a large format electrochemical cell with a pre-lithiated anode is depicted at FIG. 6B. FIG. 7 shows an example setup for such a large-format cell for use with the methodology of FIG. 6. FIG. 8 depicts example voltage control of the pre-lithiation step for large-format cells, and is discussed with regard to pre-lithiation efficiency.

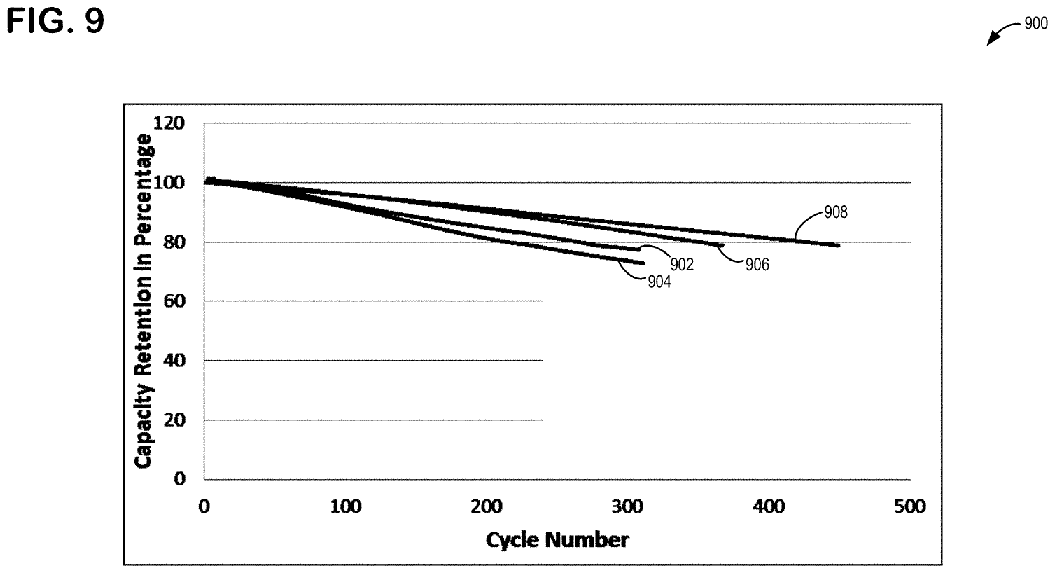

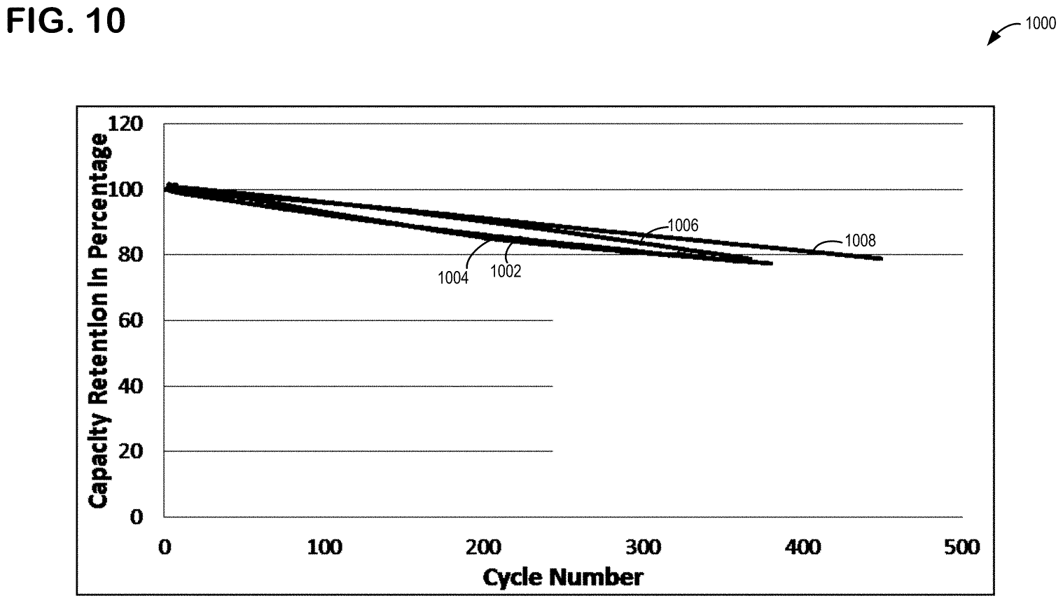

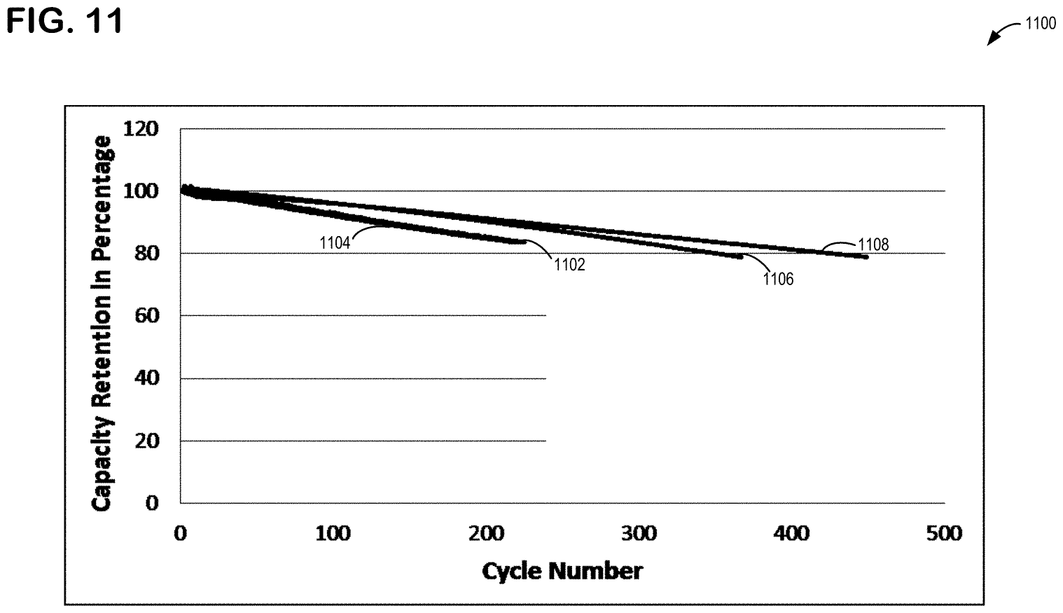

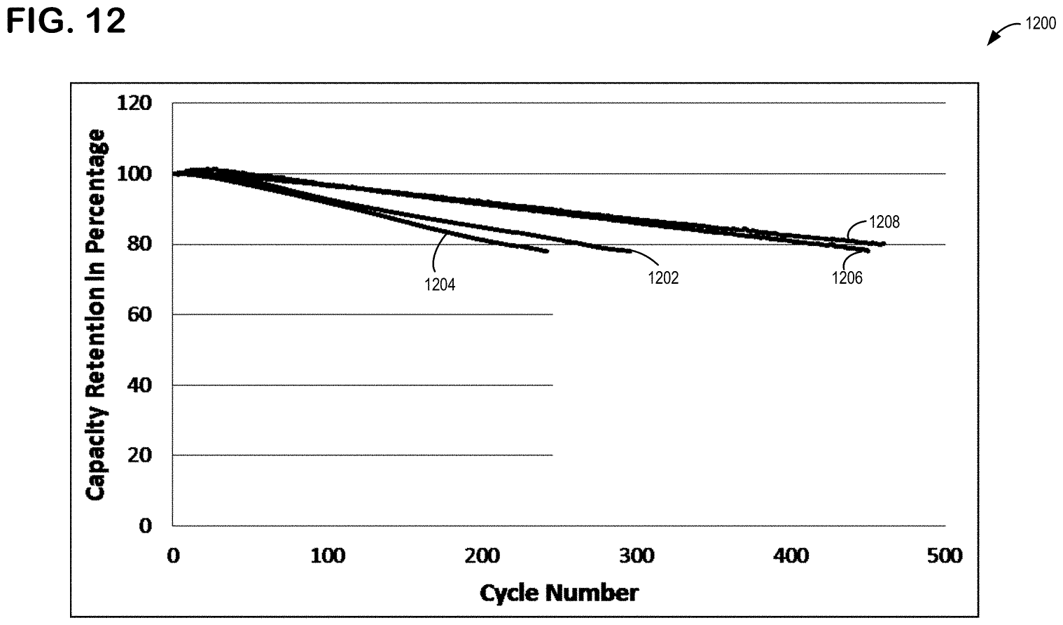

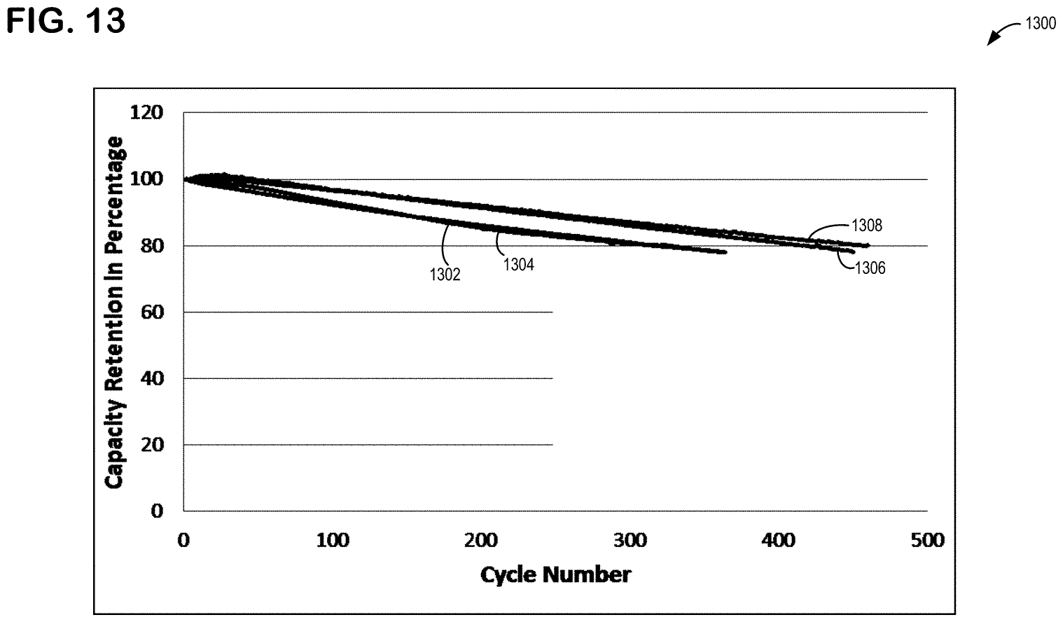

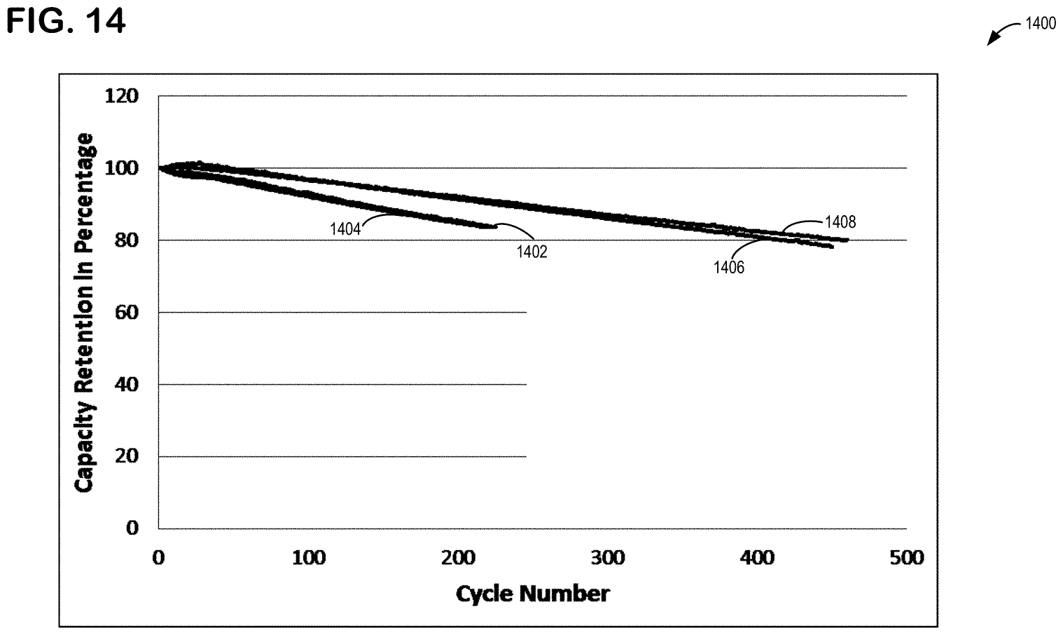

FIGS. 9-11 and FIGS. 12-14 depict example graphs comparing the pre-lithiation strategy of FIG. 1A (FIGS. 9-11) and FIG. 1B (FIGS. 12-14) with other pre-lithiation approaches in terms of cycling performance, for double-layered small pouch cells. Specifically, FIG. 9 compares cycling performance of cells generated by the strategy of FIG. 1A to the SLMP approach, FIG. 10 compares cycling performance of cells generated by the strategy of FIG. 1A to the ultra-thin Li foil approach, and FIG. 11 compares cycling performance of cells generated by the strategy of FIG. 1A to an alternative electrochemical approach. FIG. 12 compares cycling performance of cells generated by the strategy of FIG. 1B to the SLMP approach, FIG. 13 compares cycling performance of cells generated by the strategy of FIG. 1B to the ultra-thin Li foil approach, and FIG. 14 compares cycling performance of cells generated by the strategy of FIG. 1B to the alternative electrochemical approach.

As provided above, the disclosed process herein has been developed for use with three-electrode systems and improves anode pre-lithiation efficiency. Specifically, with this method the anode pre-lithiation efficiency is inversely related to anode loading amount under conditions where the anode is pre-lithiated via three-electrode systems (e.g., the electrochemical strategies of FIG. 1A or FIG. 1B). In other words, the method provides an improved the anode pre-lithiation efficiency based on an anode loading amount using a three-electrode pre-lithiation system.

Accordingly, turning to FIG. 1A, an example illustration 100 is shown depicting a process for pre-lithiation of an anode using the three-electrode strategy mentioned above where the auxiliary electrode is Li metal 108. Accordingly, at step A, depicted is pouch 102. Lithium metal 108 is placed beside a stacked cell that included anode 104 and cathode 106. Pouch 102 is then filled with electrolyte solution 110. At step B, anode 104 is conducted for a desired pre-lithiation (e.g., desired pre-lithiation percentage) by connecting Li metal 108 and anode 104 together. The Li metal 108 may work as an anode (−) while the anode 104 may work as a cathode (+) in some examples, due to a potential difference of anode 104 and Li metal 108. Accordingly, during pre-lithiation, lithium ions from Li metal 108 may migrate through electrolyte solution 110 to intercalate or alloy with anode 104. A rate of pre-lithiation may be controlled by the current density during the pre-lithiation process. As an example, a current density of C/100 may be applied for 10 hours to achieve 10% pre-lithiation. Different current density may be applied for differing amounts of time to achieve different pre-lithiation percentages. Specifically, the current density and pre-lithition time may be modified based on a desired rate and degree of anode pre-lithiation. At step C, it may be understood the pre-lithition step is completed, with anode 104 being pre-lithiated to a determined percentage, exemplified by the difference in shading of anode 104 at step C compared to step B. At step C, a heat seal 112 may be used to melt opposite sides of pouch 102 together, to seal off anode 104 and cathode 106 from Li metal 108. Pouch 102 may then cut along heat seal 112, to yield the prelithiated anode 104 and cathode 106 as depicted at step D.

Turning now to FIG. 1B, another example illustration 150 is shown depicting a process for pre-lithiation of an anode using the three-electrode strategy mentioned above, where the auxiliary electrode is LiFePO₄ 158. The process is substantially similar to the process depicted at FIG. 1A, aside from the use of LiFePO₄ 158 as the auxiliary electrode. Accordingly, the process will not be reiterated in detail, but it may be understood that the same steps (A-D) may be used to pre-lithiate the anode 104. A difference between the process of FIG. 1A and that of FIG. 1B is that at step B of FIG. 1B, anode 104 is connected with LiFePO₄ 158 instead of Li metal 108. In some examples, the LiFePO₄ 158 may work as a cathode (+) and the anode may work as an anode (−).

Using the process of FIG. 1A or FIG. 1B, experiments were conducted on small pouch cells. Specifically, for testing using small pouch cells, both double-layered (one anode layer and one cathode layer) and multi-layered cells (a plurality of anode layers and a plurality of cathode layers) were used as discussed in further detail below. The following recipe of the electrodes and electrolyte was used for the testing of small pouch cells. The cathode included 95.7% NCM622 (LiNi_{0.6}Mn_{0.2}Co_{0.2}O₂), 2% PVDF (Polyvinylidene fluoride), 1.3% VGCF (vapor grown carbon fiber), and 1% Super P (carbon black). The anode included 92.5% carbon coated Si blended with graphite composite (Si/C-graphite), 4% AG binder (Aquacharge (acrylic acid copolymer)), 1.5% SBR (styrene-butadiene rubber), 1% VGCF, and 1% Super P. The electrolyte included 40% ethyl methyl carbonate, 30% ethylene carbonate, 25% dimethyl carbonate, 5% fluoroethylene carbonate, 1% vinylene carbonate and 1% LiPF₆. Anode loading was 174 g/m².

Table 1 depicts example formation data of double-layered cells formed via the process flow of FIG. 1A using small pouch cells.

TABLE 1
Comparison of formation data of cells made via the
process of FIG. 1A (10% pre-lithiation) as compared
with a control group, for double-layered cells.

| | 1^{st} | 1^{st} | |
|---|---|---|---|
| | Charge | Discharge | |
| | Capacity | Capacity | Initial |
| | (Ah) | (Ah) | Efficiency |
| Control Cell-1 | 0.114 | 0.0880 | 77.2% |
| Control Cell-2 | 0.118 | 0.0914 | 77.5% |
| Three-electrode (Li)-1 | 0.120 | 0.100 | 83.3% |
| Three-electrode (Li)-2 | 0.111 | 0.0929 | 83.7% |

In the example of Table 1, the control group (control cell 1 and control cell 2) included cells without any pre-lithiation step. Alternatively, cells labeled as three-electrode (Li)-1 and three-electrode (Li)-2 included cells prepared via the process of FIG. 1A. As indicated via the example data in Table 1, initial coulombic efficiency improved by about 6% and the first discharge capacity (ampere hours, or Ah) increased by about 9% after 10% pre-lithiation with lithium metal as the auxiliary electrode, as compared to the non-pre-lithiated control cells. The inventors recognized that the result may be indicative of the lithium loss on the anode side being compensated during the first charge cycle with proper anode loading.

The cells depicted at Table 1 were tested for cycling performance. Turning now to FIG. 2, example graph 200 depicts percent capacity retention as a function of charge cycle number. Control cell 1 is represented by line 202, control cell 2 is represented by line 204, three-electrode (Li)-1 cell is represented by line 206, and three-electrode (Li)-2 cell is represented by line 208. At least for three-electrode (Li)-2 cell 208, a modest improvement in cycle performance is observed as compared to the control cells.

The prelithiation strategy of FIG. 1A was also tested in multi-layered cells with seven pieces of cathode and eight pieces of anode. During the testing, a potential difference was observed to exist between each anode layer in the multi-layered cell since the degree of pre-lithiation of each pre-lithiated anode was different. This may affect the cycling performance, since there may be some lithium plating at certain parts of the anodes due to the non-uniformed prelithiation. To alleviate the issue, after generating the cell as per the process of FIG. 1A, the cell was rested for 24 hours to let the lithium ions diffuse in different anode layers before running performance tests on the cell. Table 2 depicts formation data of multi-layered cells formed via the process flow of FIG. 1A using small pouch cells.

TABLE 2
Comparison of formation data of cells made via the
process of FIG. 1A (10% pre-lithiation) as compared
with a control group, for multi-layered cells.

| | 1^{st} | 1^{st} | |
|---|---|---|---|
| | Charge | Discharge | |
| | Capacity | Capacity | Initial |
| | (Ah) | (Ah) | Efficiency |
| Control Cell-1 | 0.862 | 0.663 | 76.9% |
| Control Cell-2 | 0.858 | 0.659 | 76.8% |
| Three-electrode (Li)-1 | 0.844 | 0.701 | 83.1% |
| Three-electrode (Li)-2 | 0.835 | 0.700 | 83.8% |

Referring to Table 2, the control group (control cell-1 and control cell-2) included cells without any prelithiation as baseline. Alternatively, cells labeled as three-electrode (Li)-1 and three-electrode (Li)-2 included cells prepared via the process of FIG. 1A, with 10% pre-lithiation. As indicated via Table 2, there was an increase in initial coulombic efficiency of about 6.6% and an increase of about 6% in the first discharge capacity after 10% pre-lithiation with lithium metal as the auxiliary electrode, as compared to the control cells. Such a result is indicative of the lithium loss on the anode side being compensated during the first charge cycle. On the other hand, the inventors herein have recognized that the lower capacity improvement showed the prelithiation efficiency would decrease in multi-layered and large-format cells with same anode loading.

The cells of Table 2 were also tested for cycling performance. Turning now to FIG. 3, graph 300 depicts percent capacity retention as a function of cycle number. Control cell-1 is represented by line 302, control cell-2 is represented by line 304, three-electrode (Li)-1 cell is represented by line 306, and three-electrode (Li)-2 cell is represented by line 308. As can be seen at FIG. 3, an improvement over control cells in terms of cycling performance is observed for each of the multi-layered cells (lines 306 and 308) that were pre-lithiated via the process of FIG. 1A, as compared to control cells (lines 302 and 304) which were not pre-lithiated. The total energy density of the cell may be enhanced with improved cycling performance.

The above discussion with regard to FIGS. 2-3 and Tables 1-2 pertained to cells generated by the process of FIG. 1A. The process of FIG. 1B was also similarly tested with regard to first charge capacity, first discharge capacity, initial efficiency, and cycle performance. As discussed above, the difference between the process of FIG. 1A and that of FIG. 1B is the use of LiFePO₄ (FIG. 1B) as compared with Li metal (FIG. 1A). Compared with Li metal, LiFePO₄ is relatively easy to store but its capacity is limited. Table 3 depicts formation data of double-layered cells formed via the process flow of FIG. 1B (10% pre-lithiation) using small pouch cells.

TABLE 3
Comparison of formation data of cells made via the
process of FIG. 1B (10% pre-lithiation) as compared
with a control group, for double-layered cells.

| | 1^{st} | 1^{st} | |
|---|---|---|---|
| | Charge | Discharge | |
| | Capacity | Capacity | Initial |
| | (Ah) | (Ah) | Efficiency |
| Control Cell-1 | 0.114 | 0.0880 | 77.2% |
| Control Cell-2 | 0.118 | 0.0914 | 77.5% |
| Three-electrode (LFP)-1 | 0.118 | 0.0987 | 83.6% |
| Three-electrode (LFP)-2 | 0.119 | 0.0998 | 83.9% |

Referring to example Table 3, the control group (control cell-1 and control cell-2) included cells without any pre-lithiation as baseline. Alternatively, cells labeled as three-electrode (LFP)-1 and three-electrode (LFP)-2 included cells prepared via the process of FIG. 1B. As indicated via Table 3, there was an increase in initial columbic efficiency of about 6% and an increase of about 9% in the first discharge capacity after 10% pre-lithiation with LiFePO₄ as the auxiliary electrode, as compared to the control cells. Such a result is indicative of the lithium loss on the anode side being compensated during the first charge cycle.

The cells depicted at Table 3 were also tested for cycling performance. Turning now to FIG. 4, graph 400 depicts percent capacity retention as a function of cycle number. Control cell-1 is represented by line 402, control cell-2 is represented by line 404, three-electrode (LFP)-1 cell is represented by line 406, and three-electrode (LFP)-2 cell is represented by line 408. As can be seen at FIG. 4, an improvement over control cells in terms of cycling performance is observed for each of the double-layered cells (lines 406 and 408) that were pre-lithiated via the process of FIG. 1B, as compared to control cells (lines 402 and 404) which were not pre-lithiated.

The prelithiation strategy of FIG. 1B was also tested in multi-layered cells with seven pieces of cathode and eight pieces of anode. Multiple layers of auxiliary electrodes were needed to achieve 10% pre-lithiation since the capacity of LiFePO₄ is lower than that of Li metal. Thus, the pre-lithiation process of FIG. 1B for multi-layered cells was increased in difficulty because the degree of delithiation of each LiFePO₄ layer was also different during the prelithiation step. Table 4 depicts example formation data of multi-layered cells formed via the process flow of FIG. 1B using small pouch cells.

TABLE 4
Comparison of formation data of cells made via the
process of FIG. 1B (10% pre-lithiation) as compared
with a control group, for multi-layered cells.

| | 1^{st} | 1^{st} | |
|---|---|---|---|
| | Charge | Discharge | |
| | Capacity | Capacity | Initial |
| | (Ah) | (Ah) | Efficiency |
| Control Cell-1 | 0.862 | 0.663 | 76.9% |
| Control Cell-2 | 0.858 | 0.659 | 76.8% |
| Three-electrode (LFP)-1 | 0.837 | 0.700 | 83.6% |
| Three-electrode (LFP)-2 | 0.836 | 0.703 | 84.9% |

Referring to example Table 4, the control group (control cell-1 and control cell-2) included cells without any pre-lithiation as baseline. Alternatively, cells labeled as three-electrode (LFP)-1 and three-electrode (LFP)-2 included multi-layered cells prepared via the process of FIG. 1B. As indicated via Table 4, the formation data for multi-layered cells pre-lithiated using LiFePO₄ as the auxiliary electrode showed a similar trend in improvement with regard to first discharge capacity and initial efficiency as the formation data for multi-layered cells pre-lithiated using Li metal as the auxiliary electrode (see Table 2). In other words, there was about a 6.1% increase in discharge capacity and about a 6% increase in initial coulombic efficiency for multi-layered cells prepared via the methodology of FIG. 1B, over non-pre-lithiated control cells.

The cells depicted at Table 4 were also tested for cycling performance. Turning now to FIG. 5, graph 500 depicts percent capacity retention as a function of cycle number. Control cell-1 is represented by line 502, control cell-2 is represented by line 504, three-electrode (LFP)-1 cell is represented by line 506, and three-electrode (LFP)-2 cell is represented by line 508. As can be seen at FIG. 5, there was not a similar trend in improvement in terms of cycling performance for multi-layered cells prepared via the process of FIG. 1B, as compared to the improvement in terms of cycling performance for multi-layered cells prepared via the process of FIG. 1A (see FIG. 3). In other words, while cycling performance was improved for multi-layered cells prepared via the process of FIG. 1A (see FIG. 3), such an improvement was not as pronounced for multi-layered cells prepared via the process of FIG. 1B (FIG. 5).

Thus, double-layered cells prepared via the process of FIG. 1A (e.g., Li metal as the auxiliary electrode) showed similar trends in improvements to first discharge capacity and initial coulombic efficiency as double-layered cells prepared by the process of FIG. 1B (e.g., LiFePO₄ as the auxiliary electrode). However, there was a greater improvement in cycling performance for double-layered cells prepared via the process of FIG. 1B than observed for double-layered cells prepared via the process of FIG. 1A. Alternatively, multi-layered cells prepared via the process of FIG. 1A showed similar trends in improvements to first discharge capacity and initial coulombic efficiency as multi-layered cells prepared via the process of FIG. 1B, but there was a greater improvement in cycling performance for multi-layered cells prepared via the process of FIG. 1A as compared to multi-layered cells prepared via the process of FIG. 1B.

In order to increase anode pre-lithiation efficiency in large-format cells, a process has herein been developed which determines an anode loading amount relative to anode pre-lithiation. Accordingly, turning to FIG. 6A, a high-level example method 600 is depicted for pre-lithiating an anode as a function of an anode loading amount. Method 600 begins at 602 and includes providing a three-electrode system that includes a cathode, an anode, and an auxiliary electrode. Such systems have been discussed above with regard to FIG. 1A and FIG. 1B. In one example the auxiliary electrode may be Li metal. In other examples, the auxiliary electrode may be LiFePO₄. However, while such examples are discussed, it may be understood that any material which can provide lithium source may be used as auxiliary electrode.

Proceeding to step 604, method 600 includes determining the anode loading amount, or in other words, the anode coat weight (e.g., in g/m² or in mAh/cm²). Specifically, anode loading amount may be determined based on electrochemical cell design, for example. Anode loading amount may be determined, for example, based on a desired capacity of a particular electrochemical cell design. Without a proper anode loading amount, anode pre-lithiation efficiency may be reduced or degraded, which may thus adversely impact improvements to discharge capacity and initial coulombic efficiency. In some examples, determining anode loading amount may be a function of the anode itself, such as whether the anode is graphite, silicon/graphite, silicon oxide/graphite, etc. In some examples, there may be a lower threshold, for which anode loading cannot be lower than for a particular application. As an example, anode loading may not be selected to be lower than 100 g/m² or an areal capacity of lower than 3.5 mAh/cm² for battery applications that include electric vehicles. Unless indicated otherwise, as used herein, anode loading and areal capacity values may correspond to a double-layered or double-sided coating (that is, a coating of two opposite sides of a current collector).

Thus, in some examples, anode loading for a large format cell may be in a range of 100 g/m²-190 g/m². In some examples, anode loading for a large format cell may be in a range of 105 g/m²-175 g/m². In other examples, anode loading for a large format cell may be in the range of 125-165 g/m². In other examples, anode loading for a large format cell may be in the range of 130-160 g/m². In other examples, anode loading for a large format cell may be in the range of 140-160 g/m². In still other examples, anode loading for a large format cell may be in the range of 150-160 g/m². As an example, it may be desirable to use high loading for electric vehicle cells with energy density of >250 Wh/kg. In some examples, anode loading for a large format cell may include an areal capacity in a range of 3.5 mAh/cm² to 13 mAh/cm². For example, anode loading for the large format cell may include the areal capacity in a range of 3.5 mAh/cm² to 6.5 mAh/cm² on a per layer basis. Accordingly, anode loading for a double-layered large format cell may be doubled, such that anode loading for the double-layered large format cell may include the areal capacity in a range of 7 mAh/cm² to 13 mAh/cm².

With the anode loading amount determined, method 600 may proceed to 606. At 606, method 600 includes loading the anode to the determined amount. Loading the anode to the determined amount may include mixing a slurry to obtain a homogeneous dispersion of each ingredient, and then applying the slurry to a current collector via a coating technology, such as slot die.

With the anode loaded to the determined amount, method 600 may proceed to 608. At 608, method 600 includes pre-lithiating the anode to an extent that is a function of the determined anode loading amount. Pre-lithiating the anode may be accomplished similar to that discussed at step B of FIG. 1A or FIG. 1B, for example. Pre-lithiating the anode may include controlling a current density in order to control a rate at which the anode is pre-lithiated, for example. Additionally or alternatively, pre-lithiating the anode may include controlling a duration for the pre-lithiation in order to control a degree or extent to which the anode is pre-lithiated.

The method of FIG. 6A specifically provides a process flow for improving anode pre-lithiation efficiency. The process flow of FIG. 6A may be used in a methodology for preparing a large format electrochemical cell. Accordingly, turning to FIG. 6B an example method 650 is shown for preparation of large-format cells using a three-electrode system as discussed above where an auxiliary electrode is used for anode pre-lithiation. Example method 650 is discussed below with regard to a jelly roll design, however it may be understood that the jelly roll design is a representative example, and other designs are within the scope of this disclosure.

As an example, for a large format cell with increased layers and dimensions (such as a jelly roll design), efficiency and uniformity of the anode pre-lithiation may decrease due to overpotential as well as differential degree of lithiation in each layer during the pre-lithiation step. Such issues are not specific to jelly roll designs, but are relevant to other designs as well. Such issues may thus affect the improvement of initial efficiency and discharge capacity, as compared to small pouch cells. Thus, while the method of FIG. 6B is discussed in terms of a jelly roll design, it may be understood that such an example is meant to be illustrative and other designs are within the scope of this disclosure.

Method 650 begins at 652 and includes determining cell design and anode loading (g/m²). It may be understood that the anode may include graphite, Si/graphite, SiOx/graphite, and even Si, SiOx, Sn, SnOx or combinations thereof. For example, depending on the cell design an amount of anode loading may be different for achieving uniform and efficient anode pre-lithiation.

Specifically, as mentioned briefly above, for large format cells that may have increased layers and dimensions, the amount of anode loading may impact efficiency and uniformity of the pre-lithiation step, whereas for small pouch cells anode loading may not be as critical a parameter. As an example, higher amounts of anode loading may make the anode thicker, which may not be favorable for efficient and uniform anode pre-lithiation for large format cells where the anode is of a substantially longer length that the anode of small pouch cells. However, for large format cells anode loading cannot be too low or else battery capacity may be compromised depending on the downstream application. As an example, anode loading of less than about 100 g/m² or an areal capacity of less than 3.5 mAh/cm² may not be useful for battery applications that include electric vehicles.

Thus, similar to that discussed above with regard to the method of FIG. 6A, in one example, anode loading for the large format cell may be in a range of 100 g/m²-190 g/m². In other examples, anode loading for the large format cell may be in the range of 105-175 g/m². In other examples, anode loading for the large format cell may be in the range of 125-165 g/m². In other examples, anode loading for the large format cell may be in the range of 130-160 g/m². In other examples, anode loading for the large format cell may be in the range of 140-160 g/m². In still other examples, anode loading for the large format cell may be in the range of 150-160 g/m². In some examples, anode loading for the large format cell may include an areal capacity in a range of 3.5 mAh/cm² to 13 mAh/cm². For example, anode loading for the large format cell may include the areal capacity in a range of 3.5 mAh/cm² to 6.5 mAh/cm² on a per layer basis. Accordingly, anode loading for a double-layered large format cell may be doubled, such that anode loading for the double-layered large format cell may include the areal capacity in a range of 7 mAh/cm² to 13 mAh/cm².

Proceeding to step 654, method 650 includes preparing and processing the anode based on the anode loading amount determined at step 652. Preparing and processing the anode may include the steps of coating the anode to achieve the desired amount of anode loading determined at step 652. Then, at step 656, method 650 includes assembling a jelly roll that includes the anode prepared at step 654 and a cathode. If the large format electrochemical cell design is not a jelly roll design, then at step 656, method 650 may include assembling the anode and the cathode in a manner in line with the desired design.

Proceeding to 658, method 650 includes determining the pre-lithiation level desired for the particular large format cell. Specifically, the pre-lithiation level and anode loading amount may be selected in a mutually dependent manner, or in other words, may be selected together. For example, anode pre-lithiation efficiency may decrease as anode loading increases, however there may be an upper limit for pre-lithiation which may not be larger than initial coulombic efficiency of the cathode half-cell (e.g., 91%). Here, the energy density may not be able to be improved to reach the expected value if anode loading were too low. However, with anode loading too high, improvements to the pre-lithiation efficiency may be constrained. Thus, both anode loading amount and pre-lithiation level may be considered together in a mutually dependent manner in order to achieve a specific high energy density cell.

With the pre-lithiation level determined, method 650 includes preparing the auxiliary electrode (e.g., the auxiliary electrode at FIG. 1A). As one example, because of the greater improvement in cycling performance for multi-layered cells prepared via the process of FIG. 1A as compared to the multi-layered cells prepared via the process of FIG. 1B (compare FIG. 3 with FIG. 5) while similar trends in terms of first discharge capacity and initial coulombic efficiency were observed for multi-layered cells prepared via the process of FIG. 1A and FIG. 1B (refer to table 2 and table 4 above, respectively), it may be desirable to use Li metal as the auxiliary electrode for the anode pre-lithiation step for large format cells. As such, designing/preparing the auxiliary electrode may include appropriately sizing the auxiliary electrode in terms of length and width, amount of Li, etc. However, it may be understood that other auxiliary electrodes (e.g., LiFePO₄, etc.) may be used without departing from the scope of this disclosure.

Determining the pre-lithiation level may be a function of the cell design and anode loading amount. Pre-lithiation percentage of the anode may be between a range of 5%-30% depending on the cell design. As one example, as silicon percentage of the anode increases, pre-lithiation percentage may increase as well. In other words, as silicon percentage increases, pre-lithiation percentage may be increased as compensation to achieve a target energy density.

Proceeding to 660, method 650 includes preparing the pouch that includes the jelly roll and auxiliary electrode. In other words, at step 660 the jelly roll is placed into a prepared pouch, along with the auxiliary electrode, similar to that, for example, as step A of FIG. 1A. Then, at 662, method 650 includes activating the cell by adding electrolyte to the cell so that the lithium ion can be transferred between the auxiliary electrode and the anode, and sealing the pouch.

Continuing to step 664, method 650 includes conducting the electrochemical pre-lithiation of the anode, similar to that discussed above at step B of FIG. 1A or FIG. 1B, for example. Briefly, the anode may be conducted for the desired percentage of pre-lithiation by connecting, for example, the auxiliary electrode (e.g., Li metal) and the anode together. A rate of pre-lithiation may be controlled by controlling a current density for the pre-lithiation step at 664. Additionally or alternatively, a degree of pre-lithiation may be controlled based on a duration of the pre-lithiation step at 664. As a non-limiting example, a current density of C/100 for 10 hours may be used to achieve 10% pre-lithiation.

In response to the anode being pre-lithiated to the desired percentage at 664, method 650 may proceed to 666. At 666, method 650 includes removing the auxiliary electrode. For example, the auxiliary electrode may be removed in similar fashion as that discussed above at step C of FIG. 1A or FIG. 1B. For example, a heat seal (e.g., heat seal 112 at FIG. 1A) may be formed which may seal opposite sides of the pouch together, and subsequent to the heat seal being formed, the pouch may be cut along the heat seal to remove the auxiliary electrode. With the auxiliary electrode removed, the jelly roll may be rinsed, and the pouch containing the jelly roll that includes the pre-lithiated anode and the cathode may be vacuum-sealed.

Continuing to step 668, formation and grading analysis may be conducted on the large format cell.

Turning to FIG. 7, an example illustration 700 of such a large format cell as that discussed above with regard to the method of FIG. 6, is depicted. On the left side of example illustration 700 a large format pouch cell is depicted, that includes a first side 705 and a second side 710. The first side 705 includes the auxiliary Li electrode, and the second side 710 includes the anode for pre-lithiation and the cathode. After pre-lithiation of the anode, the auxiliary electrode is removed, to yield the large format cell 712 that includes the second side 710. While not explicitly illustrated, it may be understood that a heat seal (e.g., heat seal 112 at FIG. 1A) may be used to melt opposite side of the pouch depicted at the left side of FIG. 7 together, to seal the auxiliary electrode (first side 705) from the anode and cathode (second side 710), and then the pouch may be cut along the heat sealed portion to provide the pre-lithiated large format cell 712 as depicted on the right side of FIG. 7.

As discussed above with regard to the method of FIGS. 6A-6B, a process has been developed which improves anode pre-lithiation efficiency in large format cells when using an electrochemical pre-lithiation approach such as the three-electrode systems discussed herein. Accordingly, discussed below are a few representative examples showing how the efficiency of the pre-lithiation step may be reduced without proper anode loading. With reduced efficiency of the pre-lithiation step, discharge capacity and initial coulombic efficiency may be adversely impacted.

Specifically, for illustrative purposes the strategy of FIG. 1A (where the auxiliary electrode is Li metal) is discussed herein for two batches of large-format pouch cells with different anode loading. For one batch anode loading was 172 g/m², whereas the other batch included anode loading of 190 g/m². Each batch had the same chemistries where the cathode included 94.5% NMC622, 3% PVDF, 0.5% Super-P, 2% ECP (carbon black), where the anode included 93% carbon coated Si blended with graphite (Si/C-graphite composite), 1.5% AG binder, 4% SBR, 1% VGCF, 0.5% Super-P, and where the electrolyte included WX65A1-4 (LiPF6 and carbonate solvent with some solvent additives).

Table 5 depicts formation data of large format cells with anode loading 172 g/m² after 6.5% pre-lithiation as compared to control large format cells with anode loading 172 g/m² with no pre-lithiation.

TABLE 5
Comparison of pre-lithiated (6.5%) large format cells with anode
loading of 172 g/m² as compared to control large format cells with
anode loading of 172 g/m² without pre-lithiation.

| | 1^{st} | 1^{st} | | 2^{nd} |
|---|---|---|---|---|
| | Charge | Discharge | | Discharge |
| | Capacity | Capacity | | Capacity |
| | under | under | | under |
| | 0.1 C | 0.1 C | Initial | 0.3 C |
| | (Ah) | (Ah) | Efficiency | (Ah) |
| Control Cell | 69.83 | 54.40 | 77.9% | 52.90 |
| Pre-lithiated Cell | 69.80 | 57.50 | 82.4% | 55.30 |

As indicated in example Table 5, for the pre-lithiated cell, discharge capacity was increased about 3.1 Ah under 0.1C and 2.4 Ah under 0.3C. Initial coulombic efficiency was improved about 4.5%.

Table 6 depicts formation data of large format cells with anode loading of 190 g/m² after 20% pre-lithiation as compared to control large format cells with anode loading 190 g/m² without pre-lithiation.

TABLE 6
Comparison of pre-lithiated (20%) large format cells with anode
loading of 190 g/m² as compared to control large format cells with
anode loading of 190 g/m² without pre-lithiation.

| | 1^{st} | 1^{st} | | 2^{nd} |
|---|---|---|---|---|
| | Charge | Discharge | | Discharge |
| | Capacity | Capacity | | Capacity |
| | under | under | | under |
| | 0.1 C | 0.1 C | Initial | 0.3 C |
| | (Ah) | (Ah) | Efficiency | (Ah) |
| Control Cell | 74.33 | 59.62 | 80.2% | 59.20 |
| Pre-lithiated Cell-1 | 74.53 | 61.27 | 82.2% | 60.65 |
| Pre-lithiated Cell-2 | 74.45 | 61.45 | 82.5% | 60.25 |

As indicated at example Table 6, for the pre-lithiated cells discharge capacity was increased about 1.65 Ah under 0.1C and about 1.45 Ah under 0.3C, and the initial coulombic efficiency increased by about 2%. Thus, comparison of the results of Table 5 with those of Table 6 indicates that the extent of improvement in terms of discharge capacity and initial coulombic efficiency for the cell loaded to 172 g/m² and where the anode is pre-lithiated to 6.5% is not similarly observed for the cell loaded to 190 g/m² even under 20% pre-lithiation. The large difference in improvement in terms of discharge capacity and initial coulombic efficiency for the two large format cells discussed with regard to example Table 5 and example Table 6 illustrates the importance of anode loading for the electrochemical pre-lithiation process such as that depicted at FIG. 1A or FIG. 1B.

As another representative example, large format cells with high pre-lithiation percentage but lower anode loading (e.g., lower than the anode loading depicted above for table 5) were prepared using the process flow of FIG. 1A. Specifically, large format cells with anode loading at 158 g/m² and 20% pre-lithiation were prepared with chemistries where the cathode included 97% NCM811 (LiNi_{0.8}Mn_{0.1}Co_{0.1}O₂), 2.0% PVDF, 0.25% VGCF, 0.75% ECP, where the anode included 94.5% carbon coated Si blended with graphite (Si/C-graphite composite), 3.0% AG binder, 1.5% SBR, 0.5% VGCF-H, 0.5% Super-P, and where the electrolyte included WX600 (LiPF6 and carbonate solvent+Lewis base additive). Formation data results are depicted at Table 7.

TABLE 7
Comparison of formation data of cells with anode loading 158
g/m² after 20% pre-lithiation on large format pouch cells.

| | 1^{st} | 1^{st} | | 2^{nd} |
|---|---|---|---|---|
| | Charge | Discharge | | Discharge |
| | Capacity | Capacity | | Capacity |
| | under | under | | under |
| | 0.1 C | 0.1 C | Initial | 0.3 C |
| | (Ah) | (Ah) | Efficiency | (Ah) |
| Pre-lithiated Cell-1 | 92.99 | 83.98 | 90.2% | 83.66 |
| Pre-lithiated Cell-2 | 92.36 | 83.54 | 90.5% | 83.17 |
| Pre-lithiated Cell-3 | 93.22 | 84.00 | 90.1% | 83.60 |
| Pre-lithiated Cell-4 | 92.51 | 83.31 | 90.1% | 82.81 |

Depicted at Table 7 are four different cells prepared as discussed. Comparison of Table 7 with the data of Table 6 illustrates that initial coulombic efficiency increased dramatically with 20% pre-lithiation when anode loading was 158 g/m² as compared to 20% pre-lithiation when anode loading was 190 g/m². As shown at Table 7, initial coulombic efficiency improved to approximately 90% (as used herein, “approximately” when referring to a numerical value may encompass a deviation of 2% or less). As further indicated, initial coulombic efficiency may be greater than 90% for the large-format cells of Table 7. Furthermore, the energy density of the pre-lithiated cells of Table 7 is able to achieve 300 Wh/kg. Because the prelithiation efficiency is related to anode loading in large-format cells, higher loading may be associated with a thick electrode which may increase the impedance between anode and auxiliary electrode, which may thus prevent a successful anode prelithiation.

Turning now to FIG. 8, in a large format cell, the case is different from results shown for small pouch cells, as discussed in detail above. Specifically, the overpotential of the pre-lithiation step becomes much larger and anode loading is a critical parameter with regard to efficiency of the pre-lithiation step. Accordingly, the influence of voltage profile of the pre-lithiation step to the improvement of discharge capacity and initial coulombic efficiency was examined. For the examination, two large-format cells with the same anode loading of 172 g/m² and same cell chemistries were pre-lithiated under different voltages. FIG. 8 depicts example illustration 800, where voltage is plotted against time. A first pre-lithiated cell (pre-lithiated cell-1) 805 is shown, and a second pre-lithiated cell (pre-lithiated cell-2) 810 is shown. First pre-lithiated cell 805 was conducted with 6.5% pre-lithiation with the voltage around 0V at the pre-lithiation step, while the second pre-lithiated cell 810 was conducted with 10% pre-lithiation with the voltage around −2V.

Comparison of formation data between large-format cells with different voltage control and pre-lithiation percentage at the pre-lithiation step is shown below at Table 8.

TABLE 8
Formation data for large-format cells with different
voltage control and pre-lithiation percentage
as compared to non-pre-lithiated control cell.

| | 1^{st} | 1^{st} | | 2^{nd} |
|---|---|---|---|---|
| | Charge | Discharge | | Discharge |
| | Capacity | Capacity | | Capacity |
| | under | under | | under |
| | 0.1 C | 0.1 C | Initial | 0.3 C |
| | (Ah) | (Ah) | Efficiency | (Ah) |
| Control Cell | 69.83 | 54.40 | 77.9% | 52.90 |
| Pre-lithiated Cell-1 | 69.80 | 57.50 | 82.4% | 55.30 |
| Pre-lithiated Cell-2 | 69.70 | 57.90 | 83.1% | 55.60 |

As indicated at Table 8, the first pre-lithiated cell 805 (pre-lithiated cell-1) that was pre-lithiated at a voltage around 0V showed a 3.1 Ah increase in discharge capacity with 6.5% pre-lithiation under 0.1C current density, and a 2.4 Ah increase in discharge capacity with 6.5% pre-lithiation under 0.3C current density. For the first pre-lithiated cell 805, the initial coulombic efficiency improved about 4.5%. The second pre-lithiated cell 810 (pre-lithiated cell-2) didn't show significant improvement in discharge capacity and initial coulombic efficiency when the voltage was around −2V at the pre-lithiation step, as compared to the first pre-lithiated cell 805. The data presented at Table 8 indicates that the voltage control of the pre-lithiation step is also important to the efficiency of the pre-lithiation process. The lithium ion may be reduced to Li metal at the anode surface when the voltage is too low. From the results depicted at Table 8 it may be understood that the anode of the second pre-lithiated cell 810 couldn't be pre-lithiated with the expected amount of lithium ion at the prelithiation step.

### Advantages

The electrochemical performance of pre-lithiated cells using the process of FIG. 1A was compared with other state-of-the-art technologies for anode pre-lithiation. Stabilized Lithium Metal Powder (SLMP) is one such technology. To compare the performance of pre-lithiated cells prepared by the process of FIG. 1A with the SLMP technology, an amount of SLMP was prepared for anode pre-lithiation based on 10% of anode capacity. The amount of SLMP was mixed with PVDF binder and dissolved in THF solvent to generate a mixing slurry. The mixing slurry was coated at the surface of the anode and dried on a heat tray overnight. The SLMP coated on the anode had to be activated due to a layer of Li₂CO₃ covering the surface of the SLMP particle. Activation was conducted by pressing the SLMP with pressure to break the surface layer of Li₂CO₃. The SLMP coated anode was then assembled with a cathode in a small pouch cell. The whole process described above was conducted in an argon-filled glovebox.

Table 9 shows formation data for double-layered cells generated by either the SLMP method as discussed above, or the methodology of FIG. 1A.

TABLE 9
Comparison of formation data of cells made via the process of FIG.
1A (10% pre-lithiation) as compared with cells generated via the
SLMP method (10% pre-lithiation) in double-layered pouch cells.

| | 1^{st} | 1^{st} | |
|---|---|---|---|
| | Charge | Discharge | |
| | Capacity | Capacity | Initial |
| | (Ah) | (Ah) | Efficiency |
| SLMP Prelithiation-1 | 0.120 | 0.100 | 83.3% |
| SLMP Prelithiation-2 | 0.122 | 0.102 | 83.6% |
| Three-electrode (Li)-1 | 0.120 | 0.100 | 83.3% |
| Three-electrode (Li)-2 | 0.111 | 0.0929 | 83.7% |

As indicated at Table 9, there was not much difference in discharge capacity improvement for the SLMP method (SLMP pre-lithiation-1 and SLMP pre-lithiation-2) as compared to the Li metal auxiliary electrode method of FIG. 1A (three-electrode (Li)-1 and three-electrode (Li)-2. Similarly there was not much different in initial efficiency improvement between the two methods. However, cycling performance was quite different between the two methods. Turning to FIG. 9, cycling performance for the cells of Table 8 is depicted. Graph 900 depicts percent capacity retention as a function of cycle number. The SLMP pre-lithiation-1 cell is depicted by line 902, the SLMP pre-lithiation-2 cell is depicted by line 904, the three-electrode (Li)-1 cell is represented by line 906, and the three-electrode (Li)-2 cell is represented by line 908. As can be seen at FIG. 9, the capacity of cells pre-lithiated by the SLMP method show a faster decay in capacity retention (lines 902 and 904) than those prepared via the methodology of FIG. 1A (lines 906 and 908). Specifically, cells prepared via the methodology of FIG. 1A maintained capacity above 80% for about 400 cycles while those prepared via the SLMP methodology could only last for about 300 cycles. One reason for the fast decay for cells prepared via the SLMP methodology may be due to non-uniform lithiation on the anode side. Specifically, after filling the electrolyte on the SLMP coated anode, the lithium powder may react with the anode immediately, rendering the “pre-lithiation” step via the SLMP approach uncontrollable. In comparison, the rate of pre-lithiation was controllable for the cells prepared via the method of FIG. 1A, specifically by controlling the rate of pre-lithiation by controlling the current density related to the delithiation rate of the auxiliary electrode. Furthermore, cells prepared via the method of FIG. 1A do not require any activation step (whereas cells prepared via the SLMP method do), which may simplify the process of scaling up to large format cells.

Ultra-thin Li foil represents another Li source used for anode pre-lithiation. The degree of pre-lithiation depends on the lithium amount deposited on the copper. To compare the electrochemical performance of pre-lithiated cells using the process of FIG. 1A with the ultra-thin Li foil methodology, thickness of the ultra-thin Li foil was customized based on 10% pre-lithiation of the anode. After cell assembly, the ultra-thin Li foil was placed on top of the anode directly. The direct contact between ultra-thin Li foil and the anode forms a short circuit when the electrolyte is filled in the small pouch. The ultra-thin foil thus reacts with the anode to trigger the pre-lithiation process.

Table 10 shows formation data for double-layered cells generated by either the ultra-thin foil method as discussed above, or the methodology of FIG. 1A.

TABLE 10
Comparison of formation data of cells made via the process
of FIG. 1A (10% pre-lithiation) as compared with cells
prepared via the ultra-thin Li foil method (10% pre-
lithiation) in double-layered pouch cells.

| | 1^{st} | 1^{st} | |
|---|---|---|---|
| | Charge | Discharge | |
| | Capacity | Capacity | Initial |
| | (Ah) | (Ah) | Efficiency |
| Ultra-thin Li Foil-1 | 0.106 | 0.0899 | 84.8% |
| Ultra-thin Li Foil-2 | 0.109 | 0.0923 | 84.7% |
| Three-electrode (Li)-1 | 0.120 | 0.100 | 83.3% |
| Three-electrode (Li)-2 | 0.111 | 0.0929 | 83.7% |

Similar to that observed for the SLMP method as discussed above with regard to table 8, the discharge capacity improvement was similar between cells prepared via the ultra-thin Li foil methodology (ultra-thin Li Foil-1 and ultra-thin Li foil-2) as compared to cells prepared via the process of FIG. 1A (three-electrode (Li)-1 and three-electrode (Li)-2). Initial efficiency improvement was also similar between cells prepared via the ultra-thin Li foil methodology and cells prepared via the process of FIG. 1A. However, cycling performance was improved for the cells prepared by the process of FIG. 1A. Turning to FIG. 10, cycling performance for the cells of Table 10 is depicted. Graph 1000 depicts percent capacity retention as a function of cycle number. The ultra-thin Li Foil-1 cell is depicted by line 1002, the ultra-thin Li Foil-2 cell is depicted by line 1004, the three-electrode (Li)-1 cell is depicted by line 1006 and the three-electrode (Li)-2 cell is depicted by line 1008. As can be seen at FIG. 10, the capacity retention for cells prepared by the methodology of FIG. 1A (lines 1006 and 1008) was improved over cells prepared via the ultra-thin Li foil methodology (lines 1002 and 1004).

Challenges to the pre-lithiation method using the ultra-thin Li foil included controllability of the rate and amount for pre-lithiation. Specifically, the ultra-thin foil reacts with the anode very fast and thus the rate of pre-lithiation is high. Consequently, pre-lithiation may not be conducted uniformly at the anode side, and this non-uniformity may influence the cycling performance of the cell. Another challenge to the pre-lithiation method using the ultra-thin Li foil included the fact that the amount of pre-lithiation was not easy to control because the amount of pre-lithiation is based on the thickness of the customized ultra-thin Li foil. Thus, changing the pre-lithiation amount for an anode includes generating new customized ultra-thin Li foil with a new thickness. This may increase costs associated with using the ultra-thin Li foil methodology, which may be avoided by using the process of FIG. 1A.

In another example, pre-lithiation may be processed via another electrochemical method. Specifically, with another electrochemical approach, the pre-lithiation of the anode was conducted in a specific fixture with a piece of sacrificing cathode as the lithium source. The fixture may be filled with electrolyte and connected to an electrochemical workstation to run charge process with a small constant current. The rate of pre-lithiation was controlled by current density. In such a method, a degree of pre-lithiation could be adjusted by modifying the time of charge process. In order to compare this electrochemical method with the methodology of FIG. 1A, anodes were prepared with 10% pre-lithiation using both the above-mentioned electrochemical method and the methodology of FIG. 1A in double-layered pouch cells.

Table 11 shows formation data for double-layered cells generated by either the above-mentioned electrochemical method as discussed above, or the methodology of FIG. 1A.

TABLE 11
Comparison of formation data of cells made via the
process of FIG. 1A (10% pre-lithiation) as compared
with cells prepared via the electrochemical method
(10% pre-lithiation) in double-layered pouch cells.

| | 1^{st} | 1^{st} | |
|---|---|---|---|
| | Charge | Discharge | |
| | Capacity | Capacity | Initial |
| | (Ah) | (Ah) | Efficiency |
| Electrochemical-1 | 0.110 | 0.0926 | 84.1% |
| Electrochemical-2 | 0.108 | 0.0906 | 83.9% |
| Three-electrode (Li)-1 | 0.120 | 0.100 | 83.3% |
| Three-electrode (Li)-2 | 0.111 | 0.0929 | 83.7% |

As indicated at Table 11, there was not much difference in discharge capacity improvement for the electrochemical approach (electrochemical-1 and electrochemical-2) as compared to the Li-metal auxiliary electrode method of FIG. 1A (three-electrode (Li)-1 and three-electrode (Li)-2). Similarly, there was not much difference in initial efficiency improvement between the two methods. However, the cycling performance of the cells prepared via the methodology of FIG. 1A was much better than the electrochemical approach. Turning to FIG. 11, graph 1100 depicts percent capacity retention as a function of cycle number. The electrochemical pre-lithiation cell-1 is depicted by line 1102, the electrochemical pre-lithiation cell-2 is depicted by line 1104, the three-electrode (Li) cell-1 is depicted by line 1106, and the three-electrode (Li) cell-2 is depicted by line 1108.

The reason for the cycling performance being much better for the cells prepared via the methodology of FIG. 1A as compared to the electrochemical approach may be due to the fact that after the pre-lithiation using the electrochemical approach, the pre-lithiated anode had to be stamped into a certain size in order to construct the pouch cell. In other words, the pre-lithiated anode was exposed in a dry room during stamping, welding and pouching. Exposing of the pre-lithiated anode to atmosphere in the dry room may adversely affect the pre-lithiated anode especially with regard to the pre-formed SEI layer. Alternatively, the cells prepared via the methodology of FIG. 1A avoided exposing the pre-lithiated anode to atmosphere during the entire cell assembly process. This difference may contribute to the improved cycling time for cells prepared via the methodology of FIG. 1A as compared to cells prepared via the electrochemical methodology discussed above.

The above comparisons with regard to Tables 9-11 and FIGS. 9-11 related to comparisons between the pre-lithiation methodology of FIG. 1A (e.g., use of Li metal as the auxiliary electrode) and other pre-lithiation methodologies (e.g., SLMP methodology, ultra-thin Li foil methodology, and electrochemical methodology). Discussed below are further comparisons between the pre-lithiation methodology of FIG. 1B (e.g., use of LiFePO₄ as the auxiliary electrode) and the other pre-lithiation methodologies (e.g., SLMP methodology, ultra-thin Li foil methodology, and electrochemical methodology).

Accordingly, Table 12 shows formation data for double-layered cells generated by either the above-mentioned SLMP method as discussed above, or the methodology of FIG. 1A.

TABLE 12
Comparison of the formation data between cells made
via the process of FIG. 1B (10% pre-lithiation) as
compared with cells prepared via the SLMP method (10%
pre-lithiation) in double-layered pouch cells.

| | 1^{st} | 1^{st} | |
|---|---|---|---|
| | Charge | Discharge | |
| | Capacity | Capacity | Initial |
| | (Ah) | (Ah) | Efficiency |
| SLMP Prelithiation-1 | 0.120 | 0.100 | 83.3% |
| SLMP Prelithiation-2 | 0.122 | 0.0102 | 83.6% |
| Three-electrode (LFP)-1 | 0.118 | 0.0987 | 83.6% |
| Three-electrode (LFP)-2 | 0.119 | 0.0998 | 83.9% |

As indicated at Table 12, similar improvements were seen in terms of discharge capacity and initial efficiency for cells prepared via the process of FIG. 1B and the SLMP methodology. However, cycling performance of the cells prepared via the methodology of FIG. 1B was much better than the cycling performance of the cells prepared via the SLMP methodology. Turning to FIG. 12, graph 1200 depicts percent capacity retention as a function of cycle number. The SLMP prelithiation-1 cell is depicted by line 1202, the SLMP pre-lithiation-2 cell is depicted by line 1204, the three-electrode (LFP) cell-1 is depicted by line 1206, and the three-electrode (LFP) cell-2 is depicted by line 1208.

Table 13 shows formation data for double-layered cells generated by either the above-mentioned ultra-thin Li foil method as discussed above, or the methodology of FIG. 1B.

TABLE 13
Comparison of the formation data between cells made via
the process of FIG. 1B (10% pre-lithiation) as compared
with cells prepared via the ultra-thin Li foil method
(10% pre-lithiation) in double-layered pouch cells.

| | 1^{st} | 1^{st} | |
|---|---|---|---|
| | Charge | Discharge | |
| | Capacity | Capacity | Initial |
| | (Ah) | (Ah) | Efficiency |
| Ultra-thin Li Foil-1 | 0.106 | 0.0899 | 84.8% |
| Ultra-thin Li Foil-2 | 0.109 | 0.0923 | 84.7% |
| Three-electrode (LFP)-1 | 0.118 | 0.0987 | 83.6% |
| Three-electrode (LFP)-2 | 0.119 | 0.0998 | 83.9% |

As indicated at Table 13, similar improvements were seen in terms of discharge capacity and initial efficiency for cells prepared via the process of FIG. 1B and the ultra-thin Li foil methodology. However, cycling performance of the cells prepared via the methodology of FIG. 1B was much better than the cycling performance of the cells prepared via the SLMP methodology. Turning to FIG. 13, graph 1300 depicts percent capacity retention as a function of cycle number. The ultra-thin Li foil-1 cell is depicted by line 1302, the ultra-thin Li foil-2 cell is depicted by line 1304, the three-electrode (LFP) cell-1 is depicted by line 1306, and the three-electrode (LFP) cell-2 is depicted by line 1308.

Table 14 shows formation data for double-layered cells generated by either the above-mentioned electrochemical method as discussed above, or the methodology of FIG. 1B.

TABLE 14
Comparison of the formation data between cells made via the process
of FIG. 1B (10% pre-lithiation) as compared with cells prepared
via the electrochemical method in double-layered pouch cells.

| | 1^{st} | 1^{st} | |
|---|---|---|---|
| | Charge | Discharge | |
| | Capacity | Capacity | Initial |
| | (Ah) | (Ah) | Efficiency |
| Electrochemical approach-1 | 0.110 | 0.0926 | 84.1% |
| Electrochemical approach-2 | 0.108 | 0.0906 | 83.9% |
| Three-electrode (LFP)-1 | 0.118 | 0.0987 | 83.6% |
| Three-electrode (LFP)-2 | 0.119 | 0.0998 | 83.9% |

As indicated at Table 14, similar improvements were seen in terms of discharge capacity and initial efficiency for cells prepared via the process of FIG. 1B and the electrochemical methodology. However, cycling performance of the cells prepared via the methodology of FIG. 1B was much better than the cycling performance of the cells prepared via the electrochemical methodology. Turning to FIG. 14, graph 1400 depicts percent capacity retention as a function of cycle number. The electrochemical approach-1 cell is depicted by line 1402, the electrochemical approach-2 cell is depicted by line 1404, the three-electrode (LFP) cell-1 is depicted by line 1406, and the three-electrode (LFP) cell-2 is depicted by line 1408.

In this way, methods for improving a capacity of a lithium ion battery are provided. In one example, a method for improving a capacity of a lithium ion battery comprises providing a three-electrode system including a cathode, an anode, and an auxiliary electrode; determining an anode loading amount and loading the anode to the determined anode loading amount; and pre-lithiating the anode with lithium from the auxiliary electrode, where a pre-lithiation efficiency is based on the anode loading amount. A first example of the method further includes wherein the auxiliary electrode is a lithium metal electrode. A second example of the method, optionally including the first example of the method, further includes wherein the auxiliary electrode is a lithium iron phosphate electrode. A third example of the method, optionally including one or more of the first and second examples of the method, further includes wherein the anode is a silicon oxide/graphite anode. A fourth example of the method, optionally including one or more of the first through third examples of the method, further includes wherein the anode is a silicon/graphite anode or a graphite anode. A fifth example of the method, optionally including one or more of the first through fourth examples of the method, further includes wherein the pre-lithiation efficiency increases as the anode loading amount decreases. A sixth example of the method, optionally including one or more of the first through fifth examples of the method, further comprises controlling a rate at which the anode is pre-lithiated. A seventh example of the method, optionally including one or more of the first through sixth examples of the method, further includes controlling the rate includes adjusting a current density for pre-lithiating the anode. An eighth example of the method, optionally including one or more of the first through seventh examples of the method, further comprises controlling a degree to which the anode is pre-lithiated. A ninth example of the method, optionally including one or more of the first through eighth examples of the method, further includes wherein controlling the degree includes controlling a duration over which the anode is pre-lithiated. A tenth example of the method, optionally including one or more of the first through ninth examples of the method, further includes wherein the anode loading amount comprises a loading on opposing sides of a current collector of the anode of greater than or equal to 100 g/m² or an areal capacity of greater than or equal to 7 mAh/cm². An eleventh example of the method, optionally including one or more of the first through tenth examples of the method, further includes wherein the anode loading amount comprises a loading on opposing sides of a current collector of the anode of less than or equal to 190 g/m² or an areal capacity of less than or equal to 13 mAh/cm². A twelfth example of the method, optionally including one or more of the first through eleventh examples of the method, further includes wherein pre-lithiating the anode includes pre-lithiating the anode to a predetermined pre-lithiation percentage, the predetermined pre-lithiation percentage being from 5% to 30%. A thirteenth example of the method, optionally including one or more of the first through twelfth examples of the method, further includes wherein improving the capacity includes the lithium ion battery having an initial coulombic efficiency of approximately 90%. A fourteenth example of the method of the method, optionally including one or more of the first through thirteenth examples of the method, further includes wherein improving the capacity includes the lithium ion battery having a first discharge capacity under 0.1C greater than 83 ampere hours. A fifteenth example of the method, optionally including one or more of the first through fourteenth examples of the method, further includes wherein improving the capacity includes the lithium ion battery having a second discharge capacity under 0.3C greater than 82 ampere hours. A sixteenth example of the method, optionally including one or more of the first through fifteenth examples of the method, further comprises removing the auxiliary electrode after pre-lithiating the anode. A seventeenth example of the method, optionally including one or more of the first through sixteenth examples of the method, further includes wherein pre-lithiating the anode includes electrochemically pre-lithiating the anode, where lithium ions from the auxiliary electrode migrate through an electrolyte solution to intercalate or alloy with the anode.

In another example, a method for manufacturing a large format electrochemical cell comprises providing a three-electrode system including a cathode, an anode, and an auxiliary electrode; determining an anode loading amount based on a desired design and application of the large format electrochemical cell; loading the anode to the anode loading amount; including the cathode, the anode, and the auxiliary electrode in the large format electrochemical cell; filling the large format electrochemical cell with an electrolyte solution; electrochemically pre-lithiating the anode to a desired pre-lithiation amount based on the anode loading amount; removing the auxiliary electrode, and vacuum sealing the large format electrochemical cell including the anode and the cathode. A first example of the method further includes wherein the auxiliary electrode is a lithium metal electrode or a lithium iron phosphate electrode. A second example of the method, optionally including the first example of the method, further includes wherein the anode is a silicon oxide/graphite anode or a silicon/graphite anode. A third example of the method, optionally including one or more of the first and second examples of the method, further includes wherein removing the auxiliary electrode includes forming a heat seal to seal the anode and the cathode from the auxiliary electrode, and then cutting the large format electrochemical cell along the heat seal. A fourth example of the method, optionally including one or more of the first through third examples of the method, further includes wherein subsequent to electrochemically pre-lithiating the anode and removing the auxiliary electrode, the anode is not exposed to oxygen or moisture. A fifth example of the method, optionally including one or more of the first through fourth examples of the method, further includes wherein the anode loading amount is for two opposite sides of a current collector of the anode and the anode loading amount is determined from a range of 100 g/m² to 190 g/m² or an areal capacity of 7 mAh/cm² to 13 mAh/cm². A sixth example of the method, optionally including one or more of the first through fifth examples of the method, further includes wherein the desired pre-lithiation amount of the anode is between 5% and 30% pre-lithiation. A seventh example of the method, optionally including one or more of the first through sixth examples of the method, further comprises controlling a rate and a degree at which the anode is pre-lithiated by controlling a current density and a duration for electrochemically pre-lithiating the anode. An eighth example of the method, optionally including one or more of the first through seventh examples of the method, further includes wherein electrochemically pre-lithiating the anode includes electrically connecting the anode to the auxiliary electrode.

In still another example, a large format electrochemical cell may be fabricated by a process comprising the steps of:

(a) preparing an anode in a process comprising the steps of:
(i) determining a total anode loading weight for two opposite sides of a current collector of the anode based on a desired design and application of the large format electrochemical cell, wherein determining the total anode loading weight includes selecting an anode weight from a range of 100 g/m² to 190 g/m² or an areal capacity of 7 mAh/cm² to 13 mAh/cm²; and
(ii) loading the anode to the determined total anode loading weight;

(b) providing a cathode and an auxiliary electrode and including the anode, the cathode and the auxiliary electrode in the large format electrochemical cell;

(c) bathing the cathode, the anode, and the auxiliary electrode in an electrolyte solution;

(d) electrically connecting the anode and the auxiliary electrode to pre-lithiate the anode to a desired level, wherein the desired level of pre-lithiation of the anode is between 5% and 30% pre-lithiation; and

(e) removing the auxiliary electrode and sealing the large format electrochemical cell.

A first example of the large format electrochemical cell further includes wherein a rate at which the anode is pre-lithiated to the desired level is controlled by adjusting a current density at which the anode is pre-lithiated. A second example of the large format electrochemical cell, optionally including the first example of the large format electrochemical cell, further includes wherein removing the auxiliary electrode includes forming a heat seal to melt opposite sides of the large format electrochemical cell together, and then cutting the large format electrochemical cell along the heat seal. A third example of the large format electrochemical cell, optionally including one or more of the first and second examples of the large format electrochemical cell, further includes wherein the desired level of anode pre-lithiation is a function of the determined total anode loading weight. A fourth example of the large format electrochemical cell, optionally including one or more of the first through third examples of the large format electrochemical cell, further includes wherein the large format electrochemical cell has an energy density of 300 watt-hours/kilogram. A fifth example of the large format electrochemical cell, optionally including one or more of the first through fourth examples of the large format electrochemical cell, further includes wherein the large format electrochemical cell has an initial coulombic efficiency of greater than 90%. A sixth example of the large format electrochemical cell, optionally including one or more of the first through fifth examples of the large format electrochemical cell, further includes wherein the large format electrochemical cell has a first discharge capacity under 0.1C of greater than 83 ampere hours. A seventh example of the large format electrochemical cell, optionally including one or more of the first through sixth examples of the large format electrochemical cell, further includes wherein the large format electrochemical cell has a second discharge capacity under 0.3C of greater than 82 ampere hours. An eighth example of the large format electrochemical cell, optionally including one or more of the first through seventh examples of the large format electrochemical cell, further includes wherein the anode is a silicon oxide/graphite anode or a silicon/graphite anode. A ninth example of the large format electrochemical cell, optionally including one or more of the first through eighth examples of the large format electrochemical cell, further includes wherein the auxiliary electrode is lithium metal or lithium iron phosphate.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for improving a capacity of a lithium ion battery, the method comprising:
providing a three-electrode system including a cathode, an anode, and an auxiliary electrode;
determining an anode loading amount and loading the anode to the determined anode loading amount; and
pre-lithiating the anode with lithium from the auxiliary electrode, where a pre-lithiation efficiency is based on the anode loading amount.

2. The method of claim 1, wherein the auxiliary electrode is a lithium metal electrode.

3. The method of claim 1, wherein the auxiliary electrode is a lithium iron phosphate electrode.

4. The method of claim 1, wherein the anode is a silicon oxide/graphite anode.

5. The method of claim 1, wherein the anode is a silicon/graphite anode or a graphite anode.

6. The method of claim 1, wherein the pre-lithiation efficiency increases as the anode loading amount decreases.

7. The method of claim 1, further comprising controlling a rate at which the anode is pre-lithiated.

8. The method of claim 7, wherein controlling the rate includes adjusting a current density for pre-lithiating the anode.

9. The method of claim 1, further comprising controlling a degree to which the anode is pre-lithiated.

10. The method of claim 9, wherein controlling the degree includes controlling a duration over which the anode is pre-lithiated.

11. The method of claim 1, wherein the anode loading amount comprises a loading on opposing sides of a current collector of the anode of greater than or equal to 100 g/m² or an areal capacity of greater than or equal to 7 mAh/cm².

12. The method of claim 1, wherein the anode loading amount comprises a loading on opposing sides of a current collector of the anode of less than or equal to 190 g/m² or an areal capacity of less than or equal to 13 mAh/cm².

13. The method of claim 1, wherein pre-lithiating the anode includes pre-lithiating the anode to a predetermined pre-lithiation percentage, the predetermined pre-lithiation percentage being from 5% to 30%.

14. The method of claim 1, wherein improving the capacity includes the lithium ion battery having an initial coulombic efficiency of approximately 90%.

15. The method of claim 1, wherein improving the capacity includes the lithium ion battery having a first discharge capacity under 0.1C greater than 83 ampere hours.

16. The method of claim 1, wherein improving the capacity includes the lithium ion battery having a second discharge capacity under 0.3C greater than 82 ampere hours.

17. The method of claim 1, further comprising removing the auxiliary electrode after pre-lithiating the anode.

18. The method of claim 1, wherein pre-lithiating the anode includes electrochemically pre-lithiating the anode, where lithium ions from the auxiliary electrode migrate through an electrolyte solution to intercalate or alloy with the anode.

19. A method for manufacturing a large format electrochemical cell, the method comprising:
providing a three-electrode system including a cathode, an anode, and an auxiliary electrode;
determining an anode loading amount based on a desired design and application of the large format electrochemical cell;
loading the anode to the anode loading amount;
including the cathode, the anode, and the auxiliary electrode in the large format electrochemical cell;
filling the large format electrochemical cell with an electrolyte solution;
electrochemically pre-lithiating the anode to a desired pre-lithiation amount based on the anode loading amount; and
removing the auxiliary electrode and vacuum sealing the large format electrochemical cell including the anode and the cathode.

20. The method of claim 19, wherein the auxiliary electrode is a lithium metal electrode or a lithium iron phosphate electrode.

21. The method of claim 19, wherein the anode is a silicon oxide/graphite anode or a silicon/graphite anode.

22. The method of claim 19, wherein removing the auxiliary electrode includes forming a heat seal to seal the anode and the cathode from the auxiliary electrode, and then cutting the large format electrochemical cell along the heat seal.

23. The method of claim 19, wherein subsequent to electrochemically pre-lithiating the anode and removing the auxiliary electrode, the anode is not exposed to oxygen or moisture.

24. The method of claim 19, wherein the anode loading amount is for two opposite sides of a current collector of the anode and the anode loading amount is determined from a range of 100 g/m² to 190 g/m² or an areal capacity of 7 mAh/cm² to 13 mAh/cm².

25. The method of claim 19, wherein the desired pre-lithiation amount of the anode is between 5% and 30% pre-lithiation.

26. The method of claim 19, further comprising controlling a rate and a degree at which the anode is pre-lithiated by controlling a current density and a duration for electrochemically pre-lithiating the anode.

27. The method of claim 19, wherein electrochemically pre-lithiating the anode includes electrically connecting the anode to the auxiliary electrode.

28. A large format electrochemical cell fabricated by a process comprising the steps of:
(a) preparing an anode in a process comprising the steps of:
(i) determining a total anode loading weight for two opposite sides of a current collector of the anode based on a desired design and application of the large format electrochemical cell, wherein determining the total anode loading weight includes selecting an anode weight from a range of 100 g/m² to 190 g/m² or an areal capacity of 7 mAh/cm² to 13 mAh/cm²; and
(ii) loading the anode to the determined total anode loading weight;
(b) providing a cathode and an auxiliary electrode and including the anode, the cathode, and the auxiliary electrode in the large format electrochemical cell;
(c) bathing the cathode, the anode, and the auxiliary electrode in an electrolyte solution;
(d) electrically connecting the anode and the auxiliary electrode to pre-lithiate the anode to a desired level, wherein the desired level of pre-lithiation of the anode is between 5% and 30% pre-lithiation; and
(e) removing the auxiliary electrode and sealing the large format electrochemical cell.

29. The large format electrochemical cell of claim 28, wherein a rate at which the anode is pre-lithiated to the desired level is controlled by adjusting a current density at which the anode is pre-lithiated.

30. The large format electrochemical cell of claim 28, wherein removing the auxiliary electrode includes forming a heat seal to melt opposite sides of the large format electrochemical cell together, and then cutting the large format electrochemical cell along the heat seal.

31. The large format electrochemical cell of claim 28, wherein the desired level of anode pre-lithiation is a function of the determined total anode loading weight.

32. The large format electrochemical cell of claim 28, wherein the large format electrochemical cell has an energy density of 300 watt-hours/kilogram.

33. The large format electrochemical cell of claim 28, wherein the large format electrochemical cell has an initial coulombic efficiency of greater than 90%.

34. The large format electrochemical cell of claim 28, wherein the large format electrochemical cell has a first discharge capacity under 0.1C of greater than 83 ampere hours.

35. The large format electrochemical cell of claim 28, wherein the large format electrochemical cell has a second discharge capacity under 0.3C of greater than 82 ampere hours.

36. The large format electrochemical cell of claim 28, wherein the anode is a silicon oxide/graphite anode or a silicon/graphite anode.

37. The large format electrochemical cell of claim 28, wherein the auxiliary electrode is lithium metal or lithium iron phosphate.
